(19) United States
(12) Patent Application Publication
(10) Pub. No.: US 2016/0041323 A1
(43) Pub. Date: Feb. 11, 2016

(54) LIGHT EXTRACTING DIFFUSIVE HOLOGRAM FOR DISPLAY ILLUMINATION

(71) Applicant: Qualcomm MEMS Technologies, Inc., San Diego, CA (US)

(72) Inventors: Jian Ma, Carlsbad, CA (US); Kebin Li, Fremont, CA (US); Chung-Po Huang, San Jose, CA (US); Tallis Young Chang, San Diego, CA (US); John Hyunchul Hong, San Clemente, CA (US); Mark Phung, Milpitas, CA (US); Zheng-wu Li, Milpitas, CA (US)

(21) Appl. No.: 14/455,532

(22) Filed: Aug. 8, 2014

(51) Int. Cl. G02B 5/32; G03H 1/02; G02B 26/00; G03H 1/04; F21V 8/00

(52) U.S. Cl. CPC G02B 5/32; G03H 1/0465; G02B 6/005; G02B 26/001; G03H 1/0276; G03H 1/0402; G03H 2001/0296; G03H 2001/0471; G03H 2001/0439

(57) ABSTRACT

This disclosure provides systems, methods and apparatus for illumination, such as for illuminating displays, including reflective displays. An illumination device may include a light-extracting, diffusive holographic medium. The holographic medium may be a holographic film and may be disposed on the surface of a light guide, and includes a hologram that both extracts light out of the light guide and diffuses this extracted light for propagation towards the display elements of the display. The hologram can extract light by redirecting light, which is propagating within the light guide, so that the light propagates out of the light. The diffusion occurs upon the light being redirected, as the hologram redirects the light towards the light guide in a controlled range of angles.

### TECHNICAL FIELD

This disclosure relates to illumination devices having holograms for extracting light out of a light guide, including illumination devices for displays, and to electromechanical systems.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Displays, including reflective displays, such as IMOD-based displays, may use illumination devices to provide light for generating images. Consequently, image quality and brightness is partially dependent on these illumination devices. To meet continuing market demands for higher image quality and brightness, new illumination and related devices are continually being developed.

### SUMMARY

The systems, methods and devices of this disclosure each have several innovative aspects, no single one of which is solely responsible for the desirable attributes disclosed herein.

In some implementations, a display system includes an array of reflective display elements and a front light disposed forward of the array of reflective display elements. The front light includes a light guide and a hologram that is configured to: redirect light propagating within the light guide out of the light guide and towards the array of reflective display elements; and diffuse the redirected light upon being redirected towards the array of reflective display elements.

In some other implementations, an illumination device includes a light guide and a hologram. The hologram is configured to: redirect light propagating within the light guide out of the light guide; and diffuse the redirected light upon being redirected.

In some implementations, a display system includes a light guide, and a means for redirecting the light guided within the light guide out of the light guide and for diffusing the light simultaneously with redirecting the light. The means for redirecting the light may include a hologram.

In some other implementations, a method for forming a display system includes forming a hologram, attaching the hologram to a light guide, and optically coupling the light guide to an array of display elements. The hologram is formed such that it is configured to redirect light propagating within the light guide out of the light guide and to diffuse the redirected light upon being redirected.

For the above-noted implementations, in some cases, the hologram may have a haze value of about 60 or more, including about 65 to about 80. In some implementations, the hologram may be configured such that 80% or more of light incident normal to the hologram passes through the hologram without changing directions. The hologram may be configured to redirect light to reflective display elements, which may include interferometric modulators.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a schematic side cross-sectional view of a front illumination device (front light) on a reflective display.

FIG. 2 is a graph showing the angle profile of light emitted by one example of a front light having light extraction features that provide specular reflection.

FIG. 3 is a schematic side cross-sectional view of an illumination device having a hologram that extracts light out of a light guide and diffuses the extracted light.

FIG. 4 is a schematic side cross-sectional view of a reflective display device that includes the illumination device of FIG. 3.

FIG. 5 is a schematic side cross-sectional view of the reflective display device of FIG. 4 having a cladding layer.

FIG. 6 is a flowchart illustrating a method of manufacturing a display device having a holographic light-extracting diffusive hologram.

FIG. 7 is a schematic side cross-sectional view of a system for forming a master hologram using a spatial intensity attenuator.

FIG. 8 is a schematic side cross-sectional view of a system for forming a master hologram using a temporal intensity attenuator.

FIG. 9 illustrates various types of holograms that may be formed, including transmission holograms and reflection holograms.

FIG. 10 is a schematic side cross-sectional view of a system for replicating a master hologram in a holographic medium.

FIG. 11 is a schematic side cross-sectional view of another system for replicating a master hologram in a holographic medium.

FIG. 12 is an isometric view illustration depicting two adjacent interferometric modulator (IMOD) display elements in a series or array of display elements of an IMOD display device.

FIGS. 13A and 13B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, an illumination device, which may be used as a light for a display, may include a light-extracting, diffusive hologram. The hologram may be part of a holographic medium, such as a holographic film, which may be disposed on the surface of a light guide and/or may be part of the light guide. The hologram both extracts light out of the light guide and diffuses this extracted light for propagation towards the display elements of the display. The hologram can extract light by redirecting the light, which is propagating within the light guide, so that the light propagates out of the light guide. The diffusion occurs upon the light being redirected, as the hologram redirects the light towards the light guide in a controlled range of angles. In some implementations, the illumination device may be a front light that illuminates a reflective display.

Particular implementations of the subject matter described in this disclosure can be implemented to realize one or more of the following potential advantages. The hologram can provide controlled redirection of light, thereby allowing the light to be both redirected out of the light guide and to also be redirected so that it propagates away from the hologram within a specified range of angles. This redirection within a specified range of angles allows the redirected light to be effectively diffused as it is being redirected. By controlling the angles at which light is redirected to the display elements of the display, the angles at which the redirected light strikes the display can also be controlled, thereby allowing control over the angles that light reflected off of a reflective display element travels to a viewer. Consequently, the hologram may perform the function of two optical layers—a light redirecting layer and a light diffusion layer. In some implementations, the hologram can be configured to direct more light at angles that allow the light to reflect off of the reflective display elements at angles within a view cone, thereby increasing the perceived brightness of the display and the efficiency of the illumination device. In addition, the light diffusion can increase the useable range of viewing angles for a display using the hologram as part of an illumination device. Where the display is reflective, the diffusion can also reduce glare that may be caused by specular reflection off of the reflective display elements.

Reference will now be made to the Figures, in which like numerals refer to like parts throughout.

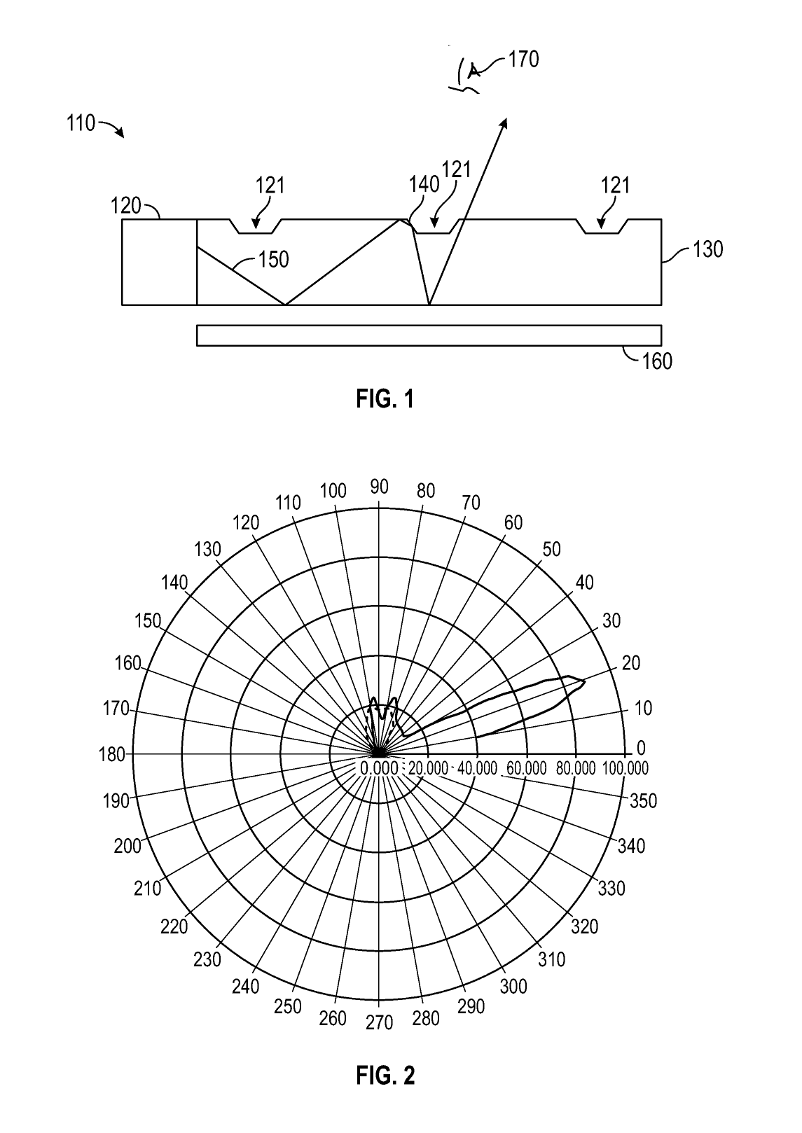

FIG. 1 is a schematic side cross-sectional view of a front illumination device (front light 110) on a reflective display 160. Reflective displays produce an image by reflecting light; for example, light from a viewer's side of the display may be reflected back towards the viewer. This reflected light may be ambient light in high ambient light conditions. In low ambient light conditions, a front light 110 may be used to provide the light that will be reflected to produce the image.

As used herein, terms such as “front” and “forward”, or “behind” and “rearward” for describing displays indicate position relative to the viewer that a display is designed to provide an image for. For example, a part may have a viewer side, facing toward the intended viewer, and a side opposite the viewer side, facing away from the intended viewer. A part that is in “front” or “forward” of another part is on the viewer side of that other part; and a part that is “behind” or “rearward” of another part is on the side opposite the viewer side of that other part. With reference to FIG. 1, the viewer is indicated by reference numeral 170.

With continued reference to FIG. 1, the illumination device 110 includes a light source 120 configured to inject light into a light guide panel 130 formed of optically-transmissive material, such as glass, plastic, etc. Light propagates through the panel by total internal reflection (TIR) until it strikes a light extraction feature 121. Surfaces 140 of the light extraction feature 121 are reflective and light striking a surface 140 is reflected downwards towards an array of reflective display elements 160. The illustrated illumination device 110 is forward of the array of reflective display elements 160 and may also be referred to as a front light.

As illustrated, the line of sight of a viewer 170 may be close to normal to the surface of the reflective display elements 160. As a result, it is desirable to have a large proportion of the light that reflects off the reflective display elements 160 propagate to the viewer 170 at angles close to the normal.

Many front lights, however, use light extraction features 121 that are mirror facets, V-grooves, or frustum total internal reflection structures, each of which have surfaces that provide specular reflection of light to the reflective display elements 160. Because light from the light source 120 may be emitted in a wide range of angles and, thus, may also strike the light extraction features 121 at a wide range of angles, the specular reflections from the light extraction features 121 may also have a wide distribution of angles. As a result, the reflected may light strike the display elements 160 at a wide range of angles. Consequently, it can be difficult to redirect light from the light source 120 so that it provides near normal illumination for the array of reflective display elements 160. In practice, the efficiency at a near normal viewing angle is often very low (for example, <1% of the light emitted by the LED may be redirected such that it is roughly normal to the display elements).

FIG. 2 is a graph showing the angle profile of light emitted by one example of a front light having light extraction features that provide specular reflection. The front light was configured to illuminate a watch-sized reflective display and the angle profile was determined at a location corresponding to the center of the reflective display. As seen in FIG. 2, a significant amount of the light illuminating the reflective display elements propagates at a sharp 20° angle relative to the array of display elements. This light is considered to be “wasted” since the viewer is unlikely to be oriented in a position to see that light. It would be desirable to more efficiently utilize the light available from the illumination device.

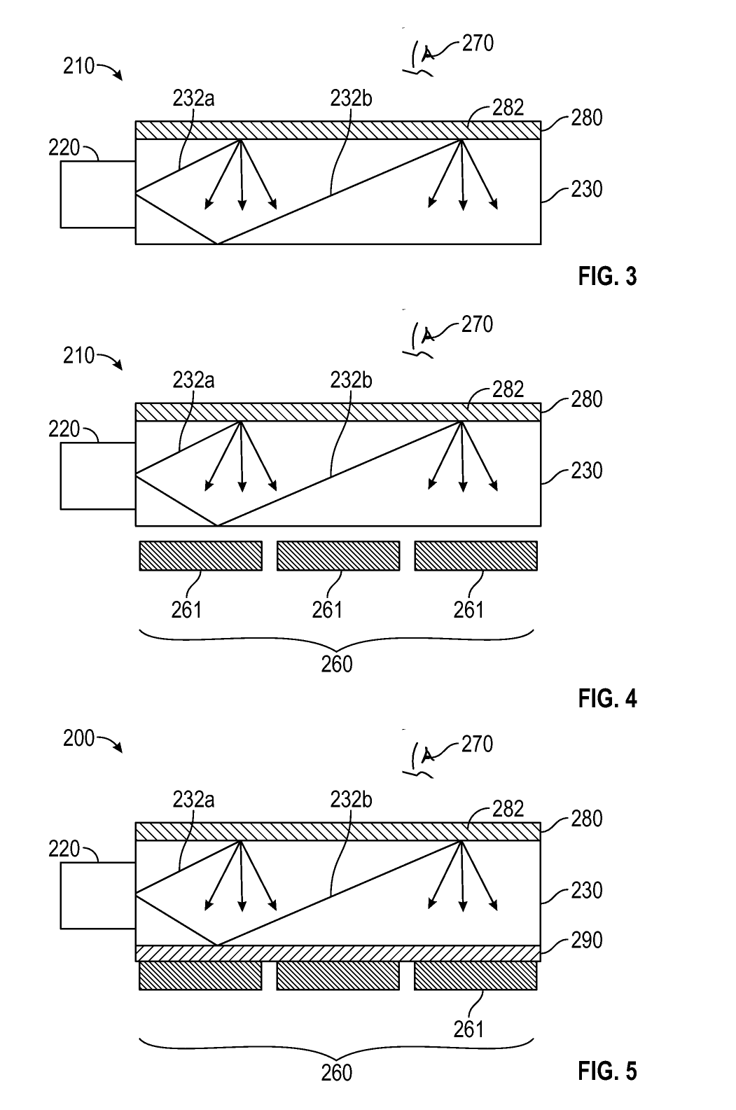

FIG. 3 is a schematic side cross-sectional view of an illumination device having a hologram that extracts light out of a light guide and diffuses the extracted light. The illumination device 210 includes a light source 220 configured to inject light into a light guide panel 230 formed of optically-transmissive material. A holographic medium 280, which may be a holographic film, is disposed on a surface of the light guide 230. The holographic medium 280 includes a hologram 282 and may be laminated on the light guide 230. Light, represented by light rays 232a and 232b, is injected by the light source 220 and propagates into and through the light guide 230 until it strikes the hologram 282. The hologram 282 redirects the light out of the light guide 230 by changing the direction of the light such that it avoids total internal reflection. Such redirection of light out of the light guide 230 may also be referred to as light extraction. As illustrated, some of the light rays, such as light ray 232b, may propagate through the light guide 230 by total internal reflection (TIR) before impinging on the hologram 282.

The hologram 282 may be a volume and/or surface hologram and may be disposed in an interior or on an exterior surface, respectively, of the holographic medium 280. In addition, the hologram 282 may include transmission and/or reflection hologram components. In some implementations, the holographic medium 280 may be part of the light guide 230 itself and the hologram 282 may be internal to the light guide 230. In such implementations, as an example, the holographic medium 280 and the light guide 230 may be formed of the same material.

The hologram 282 can redirect light by diffraction and provides a high degree of control over the angles at which the redirected light propagates. It will be appreciated the hologram allows light from a broad range of incident angles to be selectively redirected at specified angles, thereby allowing the redirected light to propagate, for example, in a normal direction to display elements. This ability to redirect light into selected directions also allows the dispersion of the redirected light to be controlled. Thus, the hologram 282 may act as a diffuser that disperses the light to create more uniform illumination and to achieve a specified viewing angle performance, such as increasing viewing angles for a display. In some implementations, the hologram 282 has a haze value of about 60 or more, or about 65 or more, including about 60 to about 80, or about 65 to about 78. The haze value indicates the percentage of light that is outside of a cone that is ±2.5° relative to the normal to the hologram. Higher numbers indicate a greater degree of diffusion with more light outside of the cone. Thus, light extraction and light diffusion functions may be incorporated in the same holographic film.

It will be appreciated that the hologram 282 can be characterized with an extraction efficiency, which indicates the amount of incident light that is redirected out of the light guide 230. A higher extraction efficiency corresponds to a larger percentage of incident light the incident being directed out of the light guide 230. In some implementations, the extraction efficiency may be the same across the entire hologram 282. In some other implementations, different parts of the hologram 282 may have different extraction efficiencies. For example, it may be desirable to provide uniform illumination, such that the amount of light extracted and propagating away from the light guide 230 is substantially uniform across that light guide 230. However, as more and more light from the light source 220 is extracted, there is less and less light propagating within the light guide 230. Consequently, the amount of light present in the light guide 230 may decrease with increasing distance from the light source 220. To counteract this decrease, in some implementations, the extraction efficiency of the hologram 282 increases with increasing distance from the light source 230. In some implementations in which there are multiple light sources 220 injecting light from different sides of the light guide 230, the extraction efficiency increases with distance from any of the light sources 230; for example, where there is a light source on each of two opposing sides of the light guide 230, the extraction efficiency of the hologram 282 may increase with distance from each of the light sources and reach a maximum extraction efficiency at the midway point between the two light sources.

Because the hologram 282 may be used as a front light forward of an array of display elements, in some implementations, the hologram 282 is configured such that a majority of the light passing through it from the display elements to the viewer side is not redirected. In some implementations, the hologram 282 is configured such that about 70% or more, about 80% or more, or about 85% or more of the light, across the array of display elements, and propagating away from (e.g. normal to) the array passes through the hologram substantially without changing directions. For example, about 70% or more, about 80% or more, or about 85% or more of light propagating normal to the array of display elements passes through the hologram 282 and propagates away from the hologram 282 without changing directions by more than +/−5 degrees, +/−2.5 degrees, or +/−1 degree.

With continued reference to FIG. 3, the light source 220 may include any suitable light source, for example, an incandescent bulb, a edge bar, a light emitting diode (“LED”), a fluorescent lamp, an LED light bar, an array of LEDs, and/or another light source. In certain implementations, light from the light source 220 is injected into the light guide 230 such that a portion of the light propagates in a direction across at least a portion of the light guide 230 at a low-graze angle relative to the surface of the light guide 230 on which the holographic film 280 is disposed, such that the light is reflected within the light guide 230 by total internal reflection (“TIR”). In some implementations, the light source 220 includes a light bar. Light entering the light bar from a light generating device (for example, a LED) may propagate along some or all of the length of the bar and exit out of a surface or edge of the light bar over a portion or all of the length of the light bar. Light exiting the light bar may enter an edge of the light guide 230, and then propagate within the light guide 230. The light source 220 may inject light into the light guide 230 through one or surfaces of the light guide 230. For example, the light source 220 may inject light through one or more edges of the light guide 230.

It will be appreciated that the light guide 230 can be formed of one or more layers of optically transmissive material. Examples of optically transmissive materials include the following: acrylics, acrylate copolymers, UV-curable resins, polycarbonates, cycloolefin polymers, polymers, organic materials, inorganic materials, silicates, alumina, sapphire, polyethylene terephthalate (PET), polyethylene terephthalate glycol (PET-G), silicon oxynitride, and/or combinations thereof. In some implementations, the optically transmissive material is a glass.

FIG. 4 is a schematic side cross-sectional view of a reflective display device that includes the illumination device 210 of FIG. 3. The illumination device 210 is disposed forward of an array 260 of reflective display elements 261 and functions as a front light.

For ease of illustration, FIG. 4 shows three display elements 261, but any suitable number of display elements may be provided in the array 260. The display elements 261 may be any suitable type of reflective display element, including, for example, interferometric modulator (IMOD) based display elements. One example of an implementation of an IMOD-based display element is illustrated in FIG. 12, which is discussed further below.

In operation, light rays 232a and 232b may be injected by the light source 220 into the light guide 230, and may be redirected by the hologram 282 toward the array 260. The light rays may then be modulated by the display elements 261 and reflected back through the front light 210 to the viewer 270.

In some implementations, TIR through the light guide 230 can be facilitated by an air gap immediately adjacent to the surface of the light guide 230 that is opposite the holographic film 280. An air gap may also be provided immediately adjacent to the holographic film 280, on a side of the holographic film 280 opposite the light guide 230. In some implementations, one or both of these air gaps can be replaced by a cladding layer.

FIG. 5 is a schematic side cross-sectional view of the reflective display device of FIG. 4 having a cladding layer 290. As illustrated, the cladding layer 290 may be disposed between the light guide 230 and the display elements 261, on the surface of the light guide 230 opposite the holographic film 280. In some implementations, the cladding layer 290 is optically transmissive and may have a refractive index lower than that of the immediately adjacent light guide or holographic film, which may facilitate TIR off of the surface on which to cladding layer 290 is disposed. For example, the refractive index of the cladding layer 290 may be approximately 0.05 or more lower, or 0.1 or more lower, than the refractive index of the light guide 230 or holographic film 280, depending upon which feature is immediately adjacent that cladding layer.

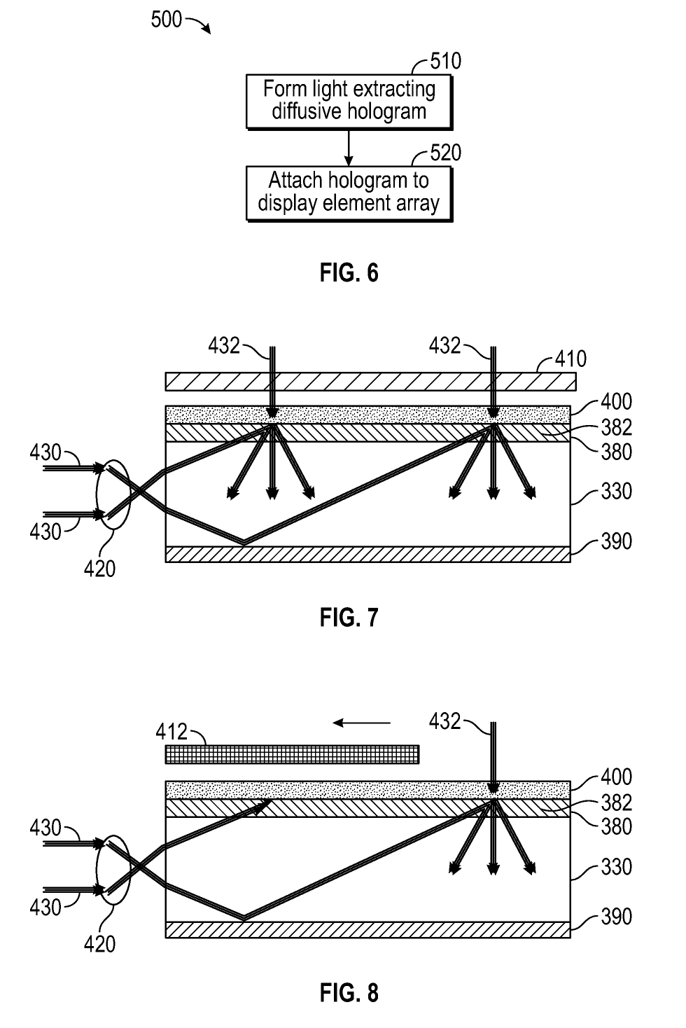

FIG. 6 is a flowchart illustrating a method of manufacturing a display device having a light-extracting diffusive hologram. The method 500 can begin in a block 510 to form the light-extracting, diffusive hologram in a holographic medium. The method 500 can then continue to a block 520 to attach the hologram, as part of the holographic film, to an array of display elements. The array of display elements can include any type of display element. For example, in some implementations, the array can include reflective display elements. An example of a reflective display element that can be used in the displays disclosed herein is an interferometric modulator (IMOD) display element, described in more detail herein. In some other implementations, the display elements may be transmissive display elements and the holographic film may be attached rearward of those display elements, so that the hologram forms part of a backlight.

Attaching the hologram to the display element array can include attaching a structure containing the hologram to the display element array or to a structure containing the display element array. For example, the hologram may be formed in a holographic film which is then laminated to a light guide and to which a light source may be attached. Subsequently, that entire structure is coupled to the array of display elements. Attaching these various structures together may take the form of chemically adhering surfaces of the structures together and/or mechanically coupling the structures together, such as by the use of screws and/or other mechanical fasteners.

Referring back to block 510, the light-extracting, diffusive hologram may be formed using a master hologram, e.g., by exposing holographic media to light transmitted through a master hologram. FIG. 7 is a schematic side cross-sectional view of a system for forming a master hologram. The system includes a light guide 330, under which is disposed a cladding layer 390. Above the light guide 330 is holographic media 380, over which is a diffuser 400, over which is a spatial intensity attenuator 410. The system also includes beam control optics 420.

The master hologram can be recorded in a holographic medium using two sets of laser beams 430 and 432, generally coming from two different directions. For example, as illustrated, the first set of laser beams 430 may be injected into the light guide 330 from the left-hand side and the second set of laser beams 432 may propagate downwards from above the holographic medium 380.

It will be appreciated that the first set of laser beams 430 may mimic the paths of light that will be injected by the light source 220 (FIGS. 3-5) in the illumination device 210 into which a hologram formed by the master hologram may later be incorporated. Consequently, the first set of laser beams 430 may travel through beam control optics 420 (e.g., a lens) before being injected into the light guide 330. The beam control optics 420 may modify the directions of the first set of laser beams 430 so that these laser beams travel in directions similar to that of the light that would be emitted by the light source 220. In addition, the second set of laser beams 432 may mimic the paths of light that is redirected by the hologram 282. For example, the second set of laser beams 432 may travel through a diffuser 400 so that this laser light propagates in the range of directions specified for light that will be redirected by the hologram 282. The diffuser 400 provides a specified diffusion property (e.g., a specified haze or full-width-half-maximum angle). The second set of laser beams 432 may be oriented normal to the holographic medium 380 and may be collimated before propagating through the diffuser 400. In some implementations, the orientation of the second set of laser beams corresponds to the expected orientation of a viewer. For example, where the line of sight of the viewer is expected to be normal to the hologram, the second set of laser beams may also travel to the hologram along a path normal to the hologram.

To facilitate matching the paths of light in the final illumination device 210 with the paths of light of the first and second set of laser beam, the light guide 330 may have similar optical properties and dimensions (e.g., refracted indices) as the light guide 230 of the final illumination device 210. In some implementations, the light guides 330 and 230 may be formed of the same material and, in some implementations, may be used in place of the illustrated light guide 230 in the final illumination device 210. In addition, where the illumination device 210 will include a cladding layer 290, the master hologram system may also include a similar cladding layer 390.

Because the wavelengths of light used to record a hologram determine the wavelengths of light that are redirected by that hologram, the wavelengths of the first and the second sets of laser beams may be selected based on the wavelengths of light that one desires to redirect in the final illumination device 210. For example, for monochrome displays, a single wavelength of light might be utilized for both the first and second sets of laser beams. In another example, for color displays, the first and the second set of laser beams may each include red, green, and blue laser beams corresponding to the colors of display elements in the color displays. Where a color display includes display elements of other colors, the laser beams may also include light of those other colors.

With continued reference to FIG. 7, as noted herein, to provide more uniform illumination and extraction of light out of a light guide, the light turning efficiency of the hologram may vary with distance from the light source. To achieve this variation, the intensity and/or duration of exposure of the hologram medium to the laser beams may be varied. In some implementations, the intensity of the second set of laser beams 432 may be modified using the spatial intensity attenuator 410, which may attenuate the intensity of those laser beams at different locations across the holographic medium. A lower intensity forms holographic features with a lower extraction efficiency. In some implementations, the intensity attenuation is greatest closest at locations closest to a light source in the final illumination device, thereby providing lower extraction efficiency closest to that light source.

In some other implementations, a shutter or other opaque structure may be moved across the hologram medium to vary the duration that different locations in the holographic medium are exposed to laser beams. This temporal variation in the exposure of the hologram medium to the laser beams causes a corresponding variation in the light extraction efficiency, with longer durations of exposure providing higher extraction efficiencies.

FIG. 8 is a schematic side cross-sectional view of a system for forming a master hologram using a temporal intensity attenuator. As illustrated, the temporal intensity attenuator 412 may be an opaque structure that blocks laser beams from impinging on the hologram medium 400. The attenuator 412 is moved relative to the hologram medium 400 to expose the hologram medium 400 to the laser beams 432. As illustrated, by moving the attenuator 412 in one direction, one may change the duration that particular parts of the hologram medium 400 are exposed to the second set of laser beams 432. In some implementations, the attenuator 412 may first cover the entire hologram medium and then open from right to left, so that the regions of the medium at the right side (corresponding to regions farther from the light source in the final illumination device) are exposed to light longer than the regions closer to the left side (corresponding to regions closer to the light source). As a result, regions of the hologram medium 380 farthest from a light source are exposed to the laser beams for the longest duration, thereby providing the highest turning efficiency in these regions.

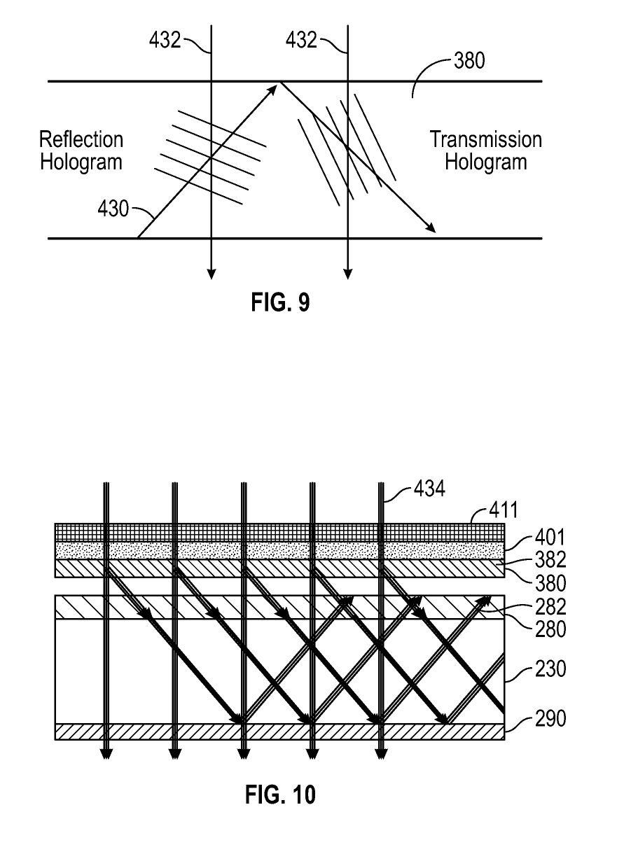

With reference to both FIGS. 7 and 8, interference between the first and the second sets of laser beams can record two types of holograms, transmission and reflection holograms. Thus, the resulting aggregate hologram may be considered to have transmission hologram components and reflection hologram components. Using the diffuser 400, many beams of different angles, originated from beam 432, emerge out of the diffuser 400 to interfere with the laser beams 430 to record hologram components that redirect light in many different directions, forming a diffuser-like light-extracting hologram. FIG. 9 illustrates various types of holograms that may be formed, including transmission holograms and reflection holograms. As illustrated, the transmission hologram components can be formed by laser beams 430 and 432 that are traveling in broadly similar directions (downwards in FIG. 9), and a reflection hologram components can be formed by laser beams 430 and 432 that are traveling in broadly opposite directions (upwards and downwards, respectively, in FIG. 9). In some implementations, interference between the first and the second sets of laser beams can induce localized changes in the refractive index of the holographic medium. These localized changes can form holographic features, which have different refractive indices than the surrounding material and which can redirect light by diffraction.

For mass production, the master hologram can be replicated. FIG. 10 is a schematic side cross-sectional view of a system for replicating a master hologram in a holographic medium. The replication system includes the light guide 230, a cladding layer 290 on one side of the light guide 230, and a hologram medium 280 on an opposite side of the light guide 230. The layer 380 containing the master hologram 382 is disposed over the holographic medium 280. A diffuser 401 and a spatial intensity attenuator 411, both similar to the diffuser 400 and the spatial intensity attenuator 410 respectively, are disposed over the holographic medium 380.

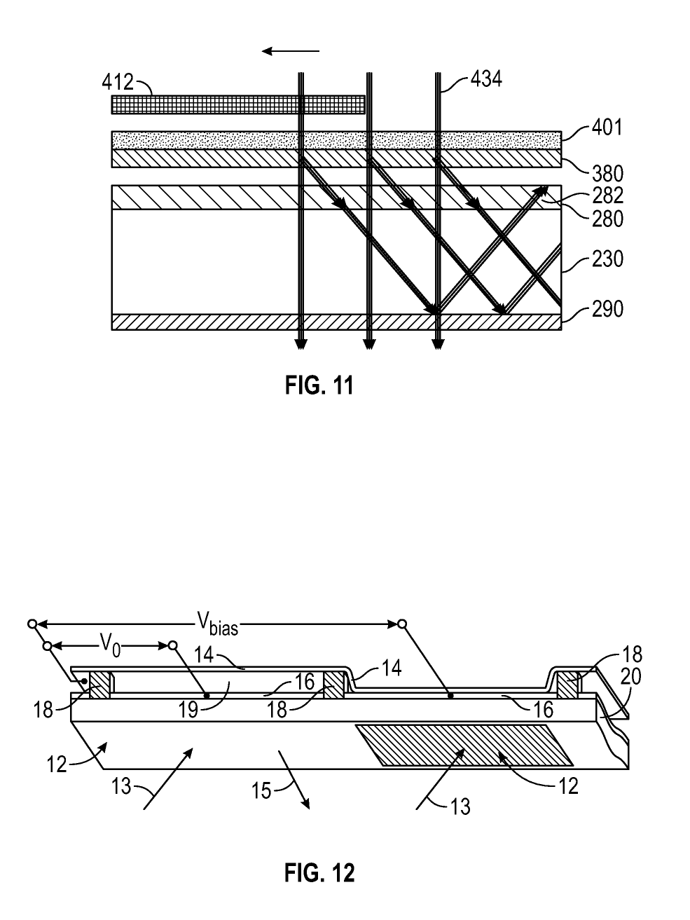

Illumination of the master hologram 382 with collimated laser beams through the attenuator 411 and diffuser 401 create reconstructed light waves substantially identical to the light waves impinging on the holographic medium 380 during the recording of the master hologram. Interference between diffracted and undiffracted laser beams records a new hologram (the replication hologram 282) into the new holographic medium 280. The cladding layer 290 may be used to replicate both transmission and reflection holograms. (In FIGS. 10 and 11, the angled beams should reach the interface of 230 and 290 and reflect back.) Thus, a replication hologram 282 is formed and is identical to the master hologram 382. In some implementations, the cladding layer 290 may be omitted. Without cladding, only the transmission part of the hologram may be replicated. In some implementations, this may still be for redirecting light so long as the total diffraction efficiency is at a selected value.

FIG. 11 is a schematic side cross-sectional view of another system for replicating a master hologram in a holographic medium. The system is similar to that illustrated in FIG. 10, except that a temporal intensity attenuator 412 is used to determine the amount of light received by the holographic medium 280. As shown, the attenuator 412 may be moved in a single direction, thereby exposing some regions of the holographic medium 280 to the laser beams 434 for longer durations than other regions.

In some other implementations, the master hologram is not used to form the hologram 282. Instead, a light-extracting, diffusive hologram may be recorded directly in the holographic medium that forms part of the final illumination device. For example, with reference to FIGS. 7 and 8, the holographic medium 380 for forming a master hologram may be replaced with a holographic medium 280 (FIGS. 3-5) and a hologram 282 may be formed in that holographic medium 280 in the same processes used to form the hologram 382. In some implementations, the holographic medium 280 may then be laminated on a light guide.

Subsequently, as noted herein, an illumination device that includes the holographic medium 280 with the hologram 282 and the light guide, may be attached in block 520 of FIG. 6 to a display element array. The display element array can include display elements, such as EMS or MEMS display elements.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 12 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 12 includes two adjacent interferometric MEMS display elements in the form of IMOD display elements 12 (which can correspond to the display elements 261 of FIGS. 3-5). In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 12, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 10 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (for example, chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (for example, of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 12, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 12. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

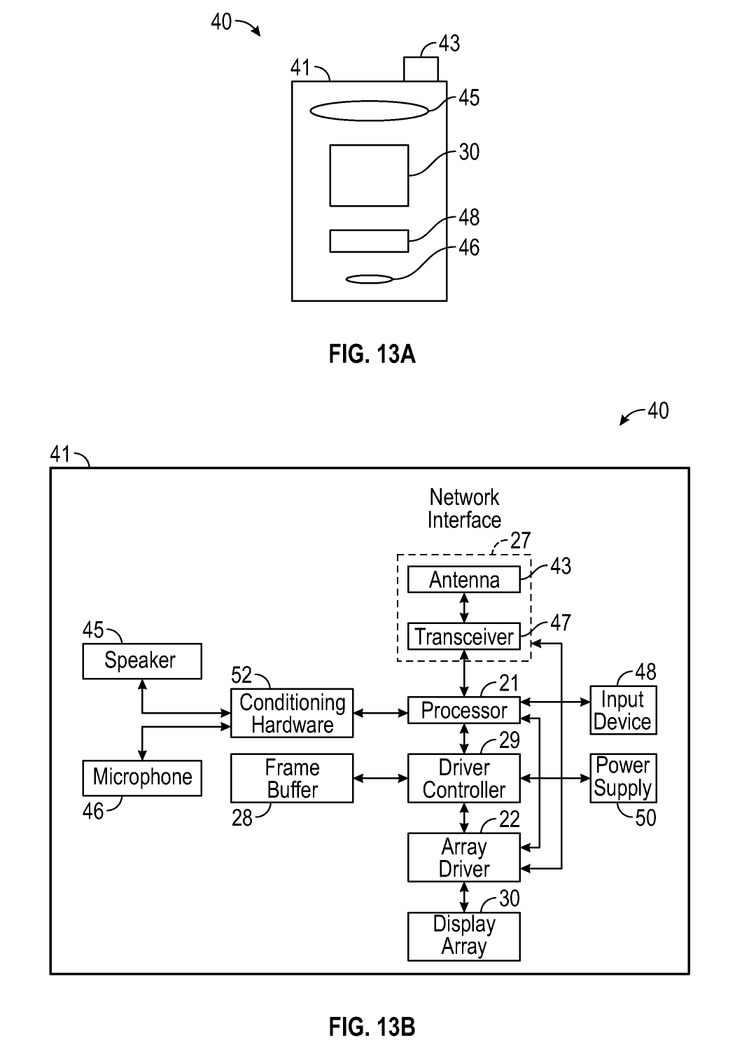

FIGS. 13A and 13B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 13A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, for example, an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display system, comprising:
an array of reflective display elements; and
a front light disposed forward of the array of reflective display elements, the front light comprising:
a light guide; and
a hologram, the hologram configured to:
redirect light propagating within the light guide out of the light guide and towards the array of reflective display elements; and
diffuse the redirected light upon being redirected towards the array of reflective display elements.

2. The system of claim 1, wherein the reflective display elements are interferometric modulators.

3. The system of claim 1, further comprising:
a processor that is configured to communicate with the array of reflective display elements, the processor being configured to process image data; and
a memory device that is configured to communicate with the processor.

4. The system of claim 3, further comprising:
a driver circuit configured to send at least one signal to the array of reflective display elements; and
a controller configured to send at least a portion of the image data to the driver circuit.

5. The system of claim 4, further comprising an image source module configured to send the image data to the processor, wherein the image source module comprises at least one of a receiver, transceiver, and transmitter.

6. The system of claim 3, further comprising an input device configured to receive input data and to communicate the input data to the processor.

7. An illumination device, comprising:
a light guide; and
a hologram, the hologram configured to:
redirect light propagating within the light guide out of the light guide; and
diffuse the redirected light upon being redirected.

8. The device of claim 7, wherein the hologram has a haze value of about 60 or more.

9. The device of claim 8, wherein the haze value is about 65 to about 80.

10. The device of claim 7, wherein the hologram is configured such that 80% or more of light incident normal to the hologram passes through the hologram without changing directions.

11. The device of claim 7, wherein the hologram is disposed in a holographic film laminated directly on the light guide.

12. The device of claim 7, further comprising a cladding layer attached to a surface of the light guide opposite the hologram.

13. The device of claim 7, wherein the hologram comprises transmission hologram components.

14. The device of claim 13, wherein the hologram further comprises reflection hologram components.

15. The device of claim 7, further comprising a light source configured to inject the light into the light guide.

16. The device of claim 15, wherein the light source includes a light emitting diode.

17. The device of claim 15, wherein a turning efficiency of the hologram increases with distance from the light source.

18. A display system, comprising:
a light guide; and
a means for redirecting the light guided within the light guide out of the light guide and for diffusing the light simultaneously with redirecting the light.

19. The system of claim 18, wherein the means comprises a hologram disposed on a surface of the light guide, the hologram configured to:
redirect light propagating within the light guide out of the light guide; and
diffuse the redirected light upon being redirected.

20. The system of claim 19, further comprising:
a light source configured to direct light into the light guide; and
an array of display elements facing the hologram, wherein the hologram is configured to redirect the light propagating within the light guide out of the light guide and towards the array of display elements.

21. The system of claim 19, wherein the hologram has a haze value of about 60 or more.

22. The system of claim 19, wherein a turning efficiency of the hologram increases with distance from the light source.

23. A method for forming a display system, comprising:
forming a hologram configured to:
redirect light propagating within the light guide out of a light guide; and
diffuse the redirected light upon being redirected;
attaching the hologram to a light guide; and
optically coupling the light guide to an array of display elements.

24. The method of claim 23, wherein forming the hologram includes:
providing a master hologram facing a holographic media supported by a second light guide, the second light guide having a cladding layer on a light guide surface opposite the holographic media; and
directing laser beams through the master hologram and the into the holographic media, thereby forming the hologram in the holographic media.

25. The method of claim 24, wherein forming the hologram further includes:
directing the laser beams through a diffuser before directing the laser beams through the master hologram.

26. The method of claim 25, wherein forming the hologram further includes:
directing the laser beams through a spatial intensity attenuator before directing the laser beams through the diffuser.

27. The method of claim 25, wherein forming the hologram further includes:
varying a duration of exposure of the holographic media to the laser beams, wherein varying the duration comprises:
opening a light blocking structure configured to block the laser beams, thereby allowing the laser beams to impinge on the holographic media.

28. The method of claim 24, wherein providing the master hologram includes:
directing a first set of laser beams through a diffuser and into a master hologram holographic media, the master hologram holographic media disposed on a light guide for forming the master hologram; and
directing a second set of laser beams through beam control optics and into the light guide for forming the master hologram.

29. The method of claim 28, wherein forming the hologram further includes:
directing the first set of laser beams through a spatial intensity attenuator before directing the first set of laser beams through the diffuser.

30. The method of claim 28, wherein forming the hologram further includes:
varying a duration of exposure of the master hologram holographic media to the first set of laser beams, wherein varying the duration comprises:
opening a light blocking structure configured to block the first set of laser beams, thereby allowing the first set of laser beams to impinge on the master hologram holographic media.
